(19) United States
(12) Patent Application Publication
(10) Pub. No.: US 2006/0164425 A1
(43) Pub. Date: Jul. 27, 2006

(54) Methods and apparatus for updating a memory address remapping table

(75) Inventor: Bruce A. Parke, Ajax (CA)

Correspondence Address: ATI TECHNOLOGIES, INC.;C/O VEDDER PRICE KAUFMAN & KAMMHOLZ, P.C., 222 N.LASALLE STREET, CHICAGO, IL, 60601, US

(73) Assignee: ATI Technologies, Inc., Markham (CA)

(21) Appl. No.: 11/041,672

(22) Filed: Jan. 24, 2005

(51) Int. Cl. G06F 12/02

(52) U.S. Cl. 345/565

(57) ABSTRACT

Methods and apparatus for updating a memory address remapping table using a graphics processing circuitry are disclosed. The methods include assembling a command sequence of commands executable by the graphics processing circuit, the sequence configured to include one or more memory address remapping table updates for one or more page entries in a memory address remapping table. The command sequence is then communicated to the graphics processing circuit for execution by the graphics processing circuit. Execution of the command sequence with the graphics processing circuit includes executing the one or more memory address remapping table updates causing the graphics processing circuit to update the one or more page entries in the memory address remapping table.

### FIELD OF INVENTION

The present disclosure relates to apparatus and methods for updating a memory address remapping table and, more particularly, to updating a memory address remapping table using commands stored in a command sequence executable by a graphics processing unit.

### BACKGROUND OF THE INVENTION

Typically in computer systems, graphics processing units (GPUs) are utilized to render graphics, video, or other data and then write the rendered or processed data to memory targets. Normally graphics processing units are configured to organize and write pixel or graphics data (or other data) to the memory target within one or more memories, which are internal to the graphics processing unit, or a memory residing external to the graphics processing unit, such as a video memory or a system memory.

It is known in computer systems to “virtualize” memory addresses in order to make discontinuous physical memory addresses appear as contiguous memory in order to make addressing memory by an application or graphics processing unit easier by simply accessing contiguous ranges of memory, rather than keeping track of discontinuous real memory addresses. In order to translate between the real addresses and the virtual memory addresses, an address remapping table (or any other suitable equivalent device, mechanism or process), is utilized, which may be stored either in a system memory or a video memory, or any other memory located in a location addressable by the graphics processing unit. As data stored in the address locations in the memory address remapping table are consumed or used, the memory address remapping table may be updated to translate to new real address locations (and, also, virtual memory locations in the table). Also, the memory address remapping table must be updated when a virtual memory address to physical memory address translation will not resolve correctly or when entries are to be removed from the memory address remapping table. The need to update the memory address remapping table requires that a physical address either be updated or be placed into the address remapping table at a determined location within the table.

In conventional computer systems, particularly those utilizing an accelerated graphics port (AGP) interface, updating of the memory address remapping table is performed by a host processing unit, such as a central processing unit (CPU). Since the CPU updates the memory and remapping table, the graphics processing unit (GPU) will sometimes be forced to sit idle while it waits for the CPU to complete or the CPU is forced to wait for the GPU to idle before the CPU can complete and update the memory address remapping table. Thus, the memory address remapping table update is not appropriately synchronized with operations performed by the graphics processing unit and performance is adversely affected consequently.

### BRIEF DESCRIPTION OF THE DRAWINGS

FIG. 1 illustrates an example of the architecture of a computing system in accordance with the present disclosure.

FIG. 2 illustrates a block diagram illustrating the sequential relationship between components of the presently disclosed methods and apparatus.

FIG. 3 illustrates a flow diagram of an example of a process for constructing a command sequence to direct a graphics processing circuit to update a memory address remapping table according to an example of the present disclosure.

FIG. 4 illustrates a flow diagram of an example of a process that may be executed by a graphics processing circuit to update a memory address remapping table in accordance with the present disclosure.

### DETAILED DESCRIPTION OF THE PREFERRED EMBODIMENTS

The present disclosure relates to methods and apparatus for updating a memory address remapping table and, in particular, providing a memory address remapping table update command in a command sequence that is executable by a graphics processing unit. In one example, in particular, a method is disclosed for updating a memory address remapping table including assembling a command sequence containing commands to be executed by the graphics processing circuit. The sequences are configured to include memory address remapping table updates for one or more page entries in the memory address remapping table. The command sequence is communicated to the graphics processing circuit for execution by the graphics processing circuit including executing the one or more memory address remapping table update commands causing the graphics processing unit to update the one or more page entries in the memory address remapping table.

Including a command sequence with commands for updating the memory address remapping table for execution by the graphics processing unit enables table updates to be queued or sequenced according to a predetermined sequence for execution. This queuing of the address remapping table updates affords accurate synchronization of the memory updates with other operations being performed by the graphics processing unit as well as synchronization with the host CPU device. Moreover, sequencing or queuing the address remapping table updates by the graphics processing unit allows the graphics processor to no longer have to wait for the CPU to complete updates of the address remapping table, as nonconventionally, when memory address remapping needs to be changed for an upcoming operation or when entries are used or consumed and need to be removed from the remapping table. All of the above features of the disclosed method and apparatus afford a performance gain in the computing system because the graphics processing unit does not have to wait or sit idle for a CPU to update the memory address remapping table, nor does the CPU have to wait for the GPU to idle, but both can continue to work asynchronously.

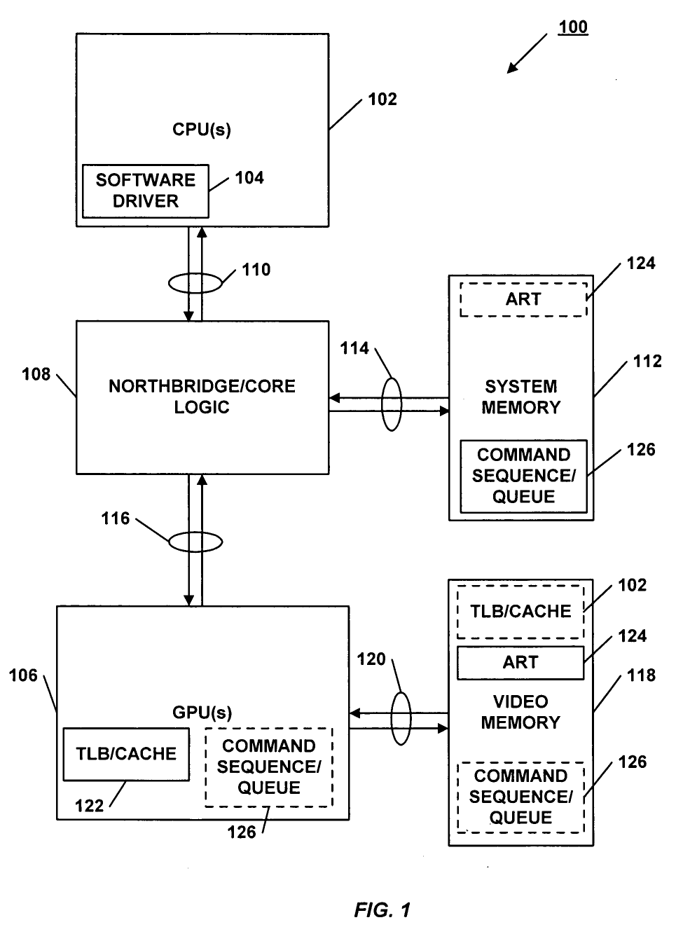

FIG. 1 illustrates a block diagram of a computing system architecture in accordance with the present disclosure. As illustrated, the architecture 100 includes at least one central processing unit 102 or any other type of processing circuitry. Running on the CPU is a software driver 104, for example, that, among other things, driving one or more graphics processing units GPU 106 or any other type of graphics processing circuitry, as well as establishing a command sequence, as will be described later. The circuit 100 also includes a Northbridge or equivalent core logic 108 in communication with the CPU 102 by a system bus 110. System memory 112 is accessible to the CPU 102 or GPU 106 through a memory interface 114 interfacing the system memory 112 and the Northbridge 108.

The GPU 106, as illustrated, connects to the Northbridge 108 via an interconnect 116, such as an AGP, PCI, or PCI Express, or other suitable interconnect. A video memory 118 is also included, which interfaces with the GPU 106 via a memory interface 120.

The graphics processing circuitry 106 also includes a translation look aside buffer or cache 122. This buffer 122 may be a table or other suitable construct that, similar to a memory address remapping table, contains cross references between virtual and real addresses, but only contains cross references between those addresses recently referenced in either the video memory 118 or the system memory 112. In other words, the translation look aside buffer 122 functions like a quick look-up index of pages in memory that have been most recently accessed.

The video memory 118 also includes a memory address remapping table 124, which, according to the present disclosure, is updated by the graphics processing unit via the memory interface 120. The memory address remapping table 124 can be stored in the video memory 118, as illustrated, but also could be stored in the system memory 112, or could be shared between the system memory 112 and video memory 118 as indicated by the table 124 shown with dashed lines.

Further, the system 100 of the present disclosure includes a command sequence or queue 126 stored in memory. This command sequence 126 is communicated to and used by the graphics processing circuitry 106 to, among other things, receive commands to update the memory address remapping table 124. Although the command sequence 126 is illustrated in FIG. 1 contained in the system memory 112, the sequence 126 could also be stored in the graphics processing circuitry 106 or the video memory 118 as illustrated by dashed lines. In the disclosed example, by storing the command sequence 126 in the system memory 112, rather than in the graphics processing circuitry 106 and/or the video memory 118, writing across the bus 116 or interface 120 is avoided. Additionally, video memory access 118 by the central processing unit 102 is avoided and a performance gain is recognized. The command sequence/queue 126 is a sequence of commands assembled by the driver 104 for execution by the graphics processing unit 106. Command sequence 126 includes, among other things, address remapping table (ART) entries that need to be updated and places these entries into the command sequence, which is accessed by the graphics processing unit 106 via bus 116, the Northbridge 108 and memory interface 114.

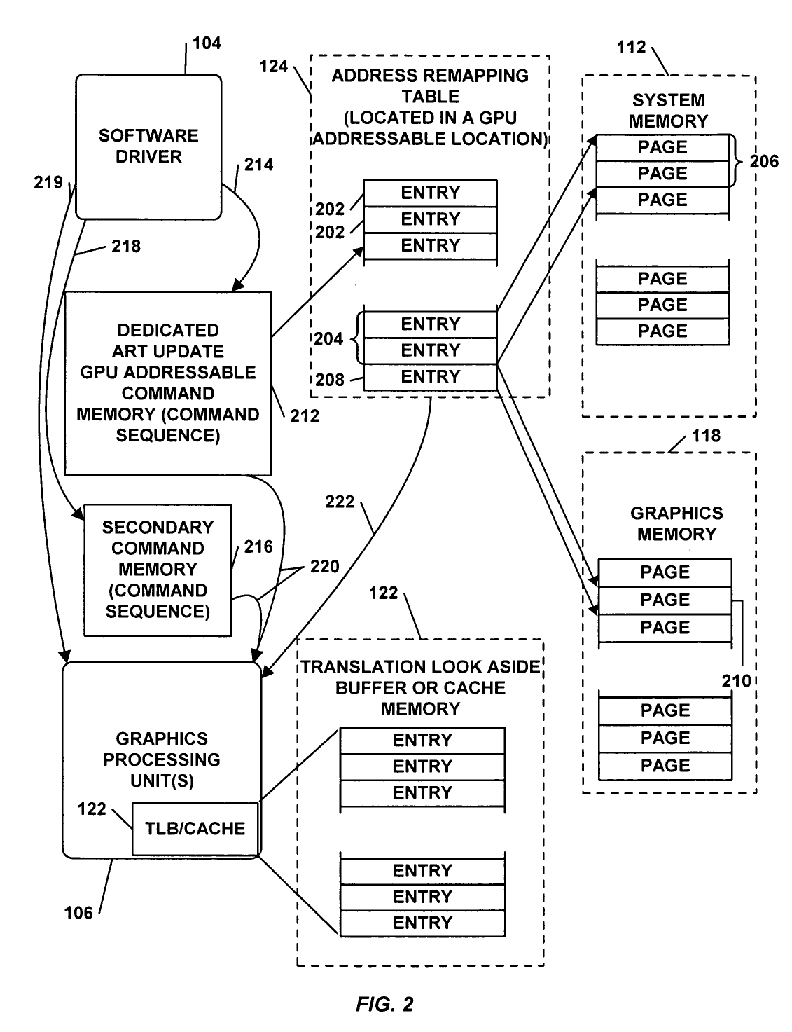

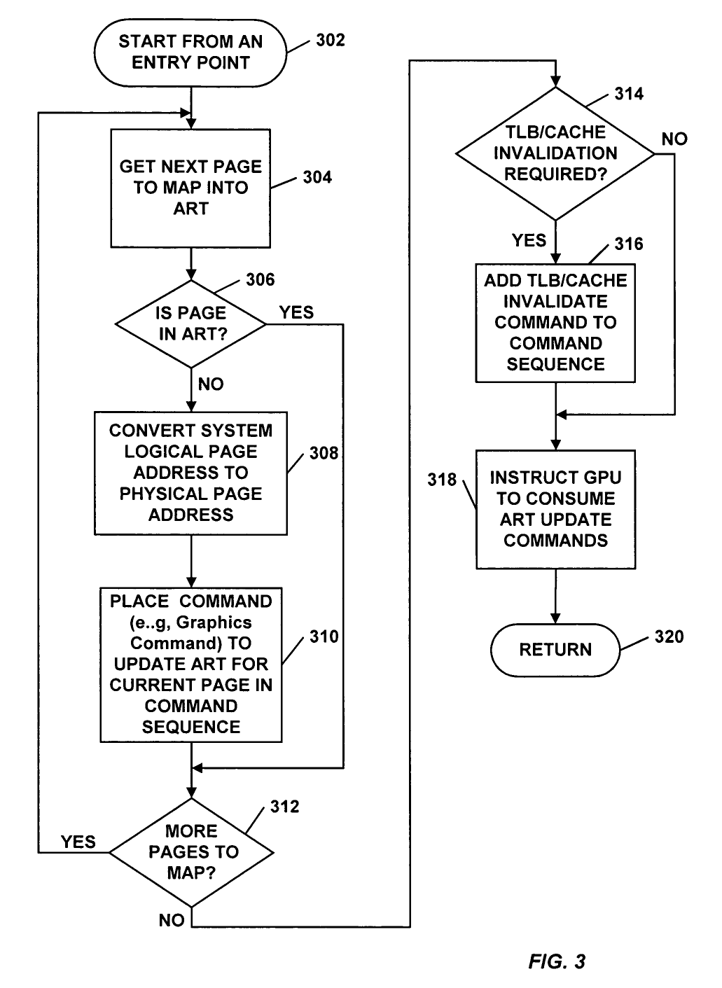

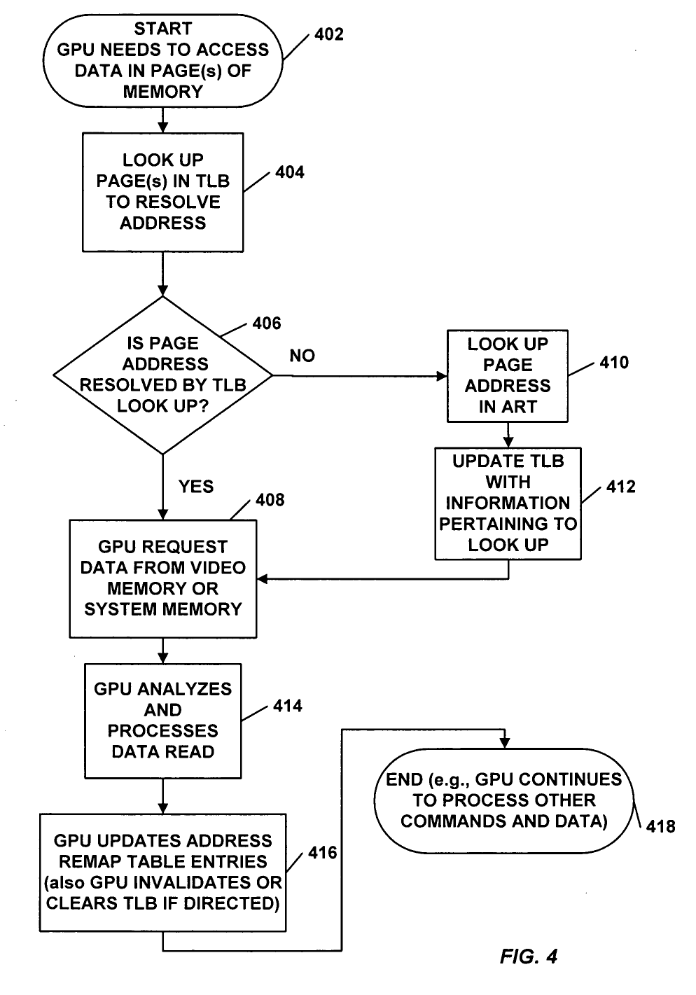

FIG. 2 illustrates a block diagram of components, which may be either hardware, software, or firmware utilized in the presently disclosed methods and apparatus, and visual representation of a sequence executed by the components, which will be also described in connection with FIGS. 3 and 4. As illustrated, the software driver 104 determines page entries in the memory address remapping table 124 that need to be updated. As illustrated, the remapping table 124 includes a number of entries 202, which contain information for translating from a virtual memory location to a real memory location within either the system memory 112 or the video memory 118. For illustrative purposes, FIG. 2 illustrates the memory address remapping table 124, which is located in the location addressable by the graphics processing unit 106. Within the memory address remapping table 124 are a plurality of entries 202, which contain information translating virtual memory addresses to real memory addresses within either the system memory 112 or the video memory 118. Within the memory address remapping table 124 a couple of entries 204, in particular, are shown to correspond to a range of pages 206 within the system memory 112, as an example. As a further example, an entry 208 is illustrated as corresponding or translating to a page 210 within the graphics memory 118.

Once the driver 104 determines which of the entries in the memory address remapping table 124 need to be updated, the driver 104 directs a dedicated ART update memory 212 (i.e., the command sequence/queue) to be created in the system memory 112 or, alternatively, in the GPU 106 or the video memory 118. This directive is indicated by sequence arrow 214. Additionally, the driver 104 may establish a secondary command memory 216 for a secondary command sequence, which is used to direct the GPU 106 during update operations of the memory address remapping table 124 to a different command queue, which may contain the instructions for updating the memory address remapping table 124. This process is indicated by sequence arrow 218. It is noted that the memories 212 and 216, which may be stored in either system memory 112, the graphics memory 118 or the graphics processing unit 106 are the same as the command sequence 126 illustrated in FIG. 1.

That is, the command sequence 126 may include just the memory 212 if a secondary command sequence is not needed to direct the graphics processing unit to a different command queue, or may include both the sequences stored in memories 212 and 216 if a secondary command sequence is desired. It is also noted that the memories 212 and 216 for storing the command sequences may be stored in one single memory (e.g., system memory 112) or across several different memory locations.

When the command sequences are written by the software driver 104 to the memories 212 and 216, the software driver 104 will communicate to the graphics processing unit 106 via the system bus 110, the Northbridge 108, and the interconnect 116 to act on the command sequences stored in the memories 212 and 216. This directive is indicated by sequence arrow 219. Once the driver 104 alerts the graphics processing unit 106 to access the command sequence in one or both of the memories 212 and 216, the graphics processing unit reads the command sequences as illustrated by arrows 220.

Additionally, the graphics processing unit 106 may access the translation look aside buffer 122, which is also illustrated in FIG. 2 in expanded form illustrating a number of page entries 122. As discussed previously, the translation look aside buffer 122 may be contained within the graphics processing circuitry 106 or, alternatively, could be located outside of the graphics processing circuitry 106, such as in the video memory 118, for example. When accessing the buffer 122, GPU 106 searches for addresses of pages of memory that the GPU 106 has accessed. If a miss occurs where the address is not in the buffer 122, the GPU 106 may search the memory address remapping table 126 as illustrated by sequence arrow 222.

The graphics processing circuitry 106 next acts on the commands contained within the command sequence. If any of the commands include a memory address remapping table update command, the GPU 106 will update the memory address remapping table 124, as directed. Additionally, the command sequence may also include instructions for the GPU 106 to invalidate the translation look aside buffer 122. The need to invalidate the translation look aside buffer 122 may arise when at least one virtual address is reused. Reuse of virtual addresses may cause the translation look aside buffer to erroneously resolve the virtual address to the wrong physical address when mapping the addresses. The graphics processing circuitry 106 then continues to process the command sequence in a predetermined or prescribed order including any further memory address remapping table updates that are in the command sequence.

FIG. 3 illustrates a flow diagram executed in the system 100 for constructing a command sequence 126 according to the present disclosure. As illustrated, the sequence 300 starts at an entry point 302. It is noted that this entry point is determined by the software driver 104 when constructing the command sequence. Flow then proceeds to block 304 where the driver 104 obtains a page entry, which translates a virtual memory location to a real memory location either in the system memory 112 or virtual memory 118 that is to be mapped into the memory address remapping table 124. It is noted that the process of converting or translating a virtual memory location to a physical or real memory location may consist of be as simple as virtual addresses mapping directly to physical addresses (i.e., no conversion).

Next, flow proceeds to decision block 306, where a determination is made whether the page entry already exists in the memory address remapping table 124. If the page is not in the memory address remapping table 124, flow proceeds to block 308 where the driver 104 converts a system logical page address (i.e., virtual memory address) to a physical page address (i.e., real memory address) is indicated in block 308.

Driver 104 next places the update command to update the memory address remapping table 124 for the current page into the command sequence as shown in block 310 based on at least one of the virtual memory address and the real memory address within the video memory 118 (or, in other system memories, such as if the address remapping table 124 is stored in the system memory 112, for example) In particular, the format of the command may be a graphics command, which will be recognized and executed by the graphics processing unit 106. It is noted, however, that any suitable format may be used that is recognizable and executable by the graphics processing circuitry 106. Additionally, the content of the command includes the memory address of the page entry in the memory address remapping table (virtual or physical), the value or data to be written to that page entry and information indicating the size of the data. After the command is created, flow then proceeds from block 310 to decision block 312, where a determination is made whether more page entries are required to be mapped.

Alternatively at block 306, if the page is already extant in the memory address remapping table 124, blocks 308 and 310 are skipped and flow proceeds directly to decision block 312. At block 312, if more pages are required to be mapped, flow proceeds back to block 304 as illustrated. If no more pages are to be mapped flow then proceeds to decision block 314, where a determination is made whether or not the translation look aside buffer or similar cash requires invalidation. An example of when invalidation would be required, but not limited to this example, is when the same virtual address has to be retargeted to a different physical address.

If, at block 314, invalidation is required, flow proceeds to block 316 where a command to invalidate the translation look aside buffer 122 is added to the command sequence. Alternatively, if no invalidation is required, block 316 is skipped as illustrated. Flow then proceeds to block 318 where the driver 104 instructs the GPU 106 to consume the command sequence, including the memory address remapping table update commands. It is noted that this part of the sequence is analogous to the sequence step 219 illustrated in FIG. 2. Once the directive of block 318 is given, flow proceeds to block 320 where the driver 104 returns to other processing.

FIG. 4 illustrates the process executed by the GPU 106 when receiving the command sequence and being directed by the driver 104 to consume the commands within the command sequence. As illustrated, the sequence 400 starts at block 402 where the GPU 106 is directed to access data in pages of memory, whether system memory 112 or video memory 118. Flow then proceeds to block 404 where the GPU 106 executes a command directing the GPU 106 to attempt looking up the page or pages in memory in order to resolve the address or addresses as indicated in block 404. Flow then proceeds to decision block 406, where the determination is made whether the page address was resolved by lookup in the translation look aside buffer 122. If the address was resolved, flow proceeds to block 408, where the GPU 106 then makes a memory request for the data from either the video memory 118 or the system memory 112.

Alternatively, if the page address was not resolved by lookup in the translation look aside buffer 122 as determined in block 406, flow proceeds to block 410 where the GPU 106 looks up the page address or addresses in the memory address remapping table 124 as indicated in block 410. Flow then proceeds to block 412 where the graphics processing unit 106 updates the translation look aside buffer 122 with the information pertaining to that particular look up in the memory address remapping table 124 in order to afford quick resolution of that address the next time the particular data in the address is requested. Flow then proceeds to block 408, which was discussed above.

Next, the GPU 106 analyzes and processes the data read from the particular memory address location as indicated in block 414. Flow then proceeds to block 416 where the GPU updates the entries in the memory address remapping table 124. Namely, the flow process in block 414 includes the consumption or execution of commands within the command sequence, which the driver 104 directed the GPU 106 to access and execute. If the command sequence also contains commands to invalidate the translation look aside buffer 122 or similar cache, the GPU 106 invalidates or clears the buffer 122 also at block 416. Flow then proceeds to block 418 where the process ends for a particular address and the GPU 106 continues to process other commands within the command sequence, including any further memory address remapping table updates and any other data to be processed.

By the presently disclosed methods and apparatus afford accurate synchronization of memory address remapping table updates with other operations being executed by the graphics processing unit 106. Moreover, because the software driver 104, which is run by the CPU 102, need only direct the GPU 106 to access and execute the assembled command sequence, the GPU 106 does not have to wait for the central processing unit 102 to finish current operations in order to update the memory address remapping table 124, nor does the CPU 102 need to wait for the GPU 106 to finish current operations. Thus, in effect, the graphics processing unit 106 is better and more accurately synchronized with the host processing (i.e., processing by the CPU 102).

The above detailed description of the present examples has been presented for the purposes of illustration and description only and not by limitation. It is therefore contemplated that the present application cover any additional modifications, variations, or equivalents but fall within the spirit and scope of the basic underlying principles disclosed above and the appended claims.

What is claimed is:

1. A method for updating a memory address remapping table comprising:
assembling a command sequence of commands executable by the graphics processing circuit, the sequence configured to include one or more memory address remapping table updates for one or more page entries in a memory address remapping table;
communicating the command sequence to the graphics processing circuit for execution by the graphics processing circuit; and
executing the command sequence with the graphics processing circuit including executing the one or more memory address remapping table updates causing the graphics processing circuit to update the one or more page entries in the memory address remapping table.

2. The method as defined in claim 1, wherein the command sequence further includes a command directing the graphic processing circuit to look for page entries in a translation look aside buffer to resolve an address.

3. The method as defined in claim 2, wherein the graphics processing circuit is further directed to look for page entries in the memory address when the graphic processing circuit does not resolve the address by looking for the page entries in the translation look aside buffer.

4. The method as defined in claim 1 further comprising:
assembling a secondary command sequence, where at least one of the commands in the command sequence directs the graphics processing circuit to the secondary command sequence including at least one further memory address remapping table update for at least one further page entry in the memory address remapping table

5. The method as defined in claim 1, wherein the command sequence includes a command to invalidate a translation look aside buffer.

6. A storage medium comprising:
memory containing executable instructions such that when processed by one or more processors causes at least one processor to:
assemble a command sequence of commands executable by the graphics processing circuit, the sequence configured to include one or more memory address remapping table updates for one or more page entries in a memory address remapping table;
communicate the command sequence to the graphics processing circuit for execution by the graphics processing circuit; and
execute the command sequence with the graphics processing circuit including executing the one or more memory address remapping table updates causing the graphics processing circuit to update the one or more page entries in the memory address remapping table.

7. The storage medium as defined in claim 6, wherein the command sequence further includes a command directing the graphic processing circuit to look for page entries in a translation look aside buffer to resolve an address.

8. The storage medium as defined in claim 7, wherein the memory contains further executable instructions such that when processed by the one or more processors causes the at least one processor to:
direct the graphics processing circuit to look for page entries in the memory address when the graphic processing circuit does not resolve the address by looking for the page entries in the translation look aside buffer.

9. The storage medium as defined in claim 6, wherein the memory contains further executable instructions such that when processed by the one or more processors causes the at least one processor to:
assemble a secondary command sequence, where at least one of the commands in the command sequence directs the graphics processing circuit to the secondary command sequence including at least one further memory address remapping table update for at least one further page entry in the memory address remapping table

10. The storage medium as defined in claim 6, wherein the command sequence includes a command to invalidate a translation look aside buffer.

11. A method for assembling a command sequence executable by a graphics processing circuit, the sequence including memory address remapping table update commands, the method comprising:
obtaining at least one page entry to be mapped into the memory address remapping table;
converting a virtual memory address of the at least one page entry to a real memory address; and
inserting at least one command into the command sequence, which is executable by the graphics processing circuit, to update the memory address remapping table based on at least the real memory address of the at least one page entry.

12. The method as defined in claim 11, further comprising:
inserting at least one further command to invalidate at least one page entry in a translation look aside buffer.

13. The method as defined in claim 11, further comprising:
assembling a secondary command sequence; and
inserting at least one command in the command sequence directing the graphics processing circuit to the secondary command sequence.

14. The method as defined in claim 13, wherein the secondary command sequence includes at least one further command executable by the graphic processing circuit memory to update the memory address remapping table based on at least the real memory address of the at least one page entry.

15. A storage medium comprising:
memory containing executable instructions such that when processed by one or more processors causes at least one processor to:
obtain at least one page entry to be mapped into the memory address remapping table;
convert a virtual memory address of the at least one page entry to a real memory address; and
insert at least one command into the command sequence, which is executable by the graphics processing circuit, to update the memory address remapping table based on at least the real memory address of the at least one page entry.

16. The storage medium as defined in claim 15, wherein the memory contains further executable instructions such that when processed by the one or more processors causes the at least one processor to:
insert at least one further command to invalidate at least one page entry in a translation look aside buffer.

17. The storage medium as defined in claim 15, wherein the memory contains further executable instructions such that when processed by the one or more processors causes the at least one processor to:
assemble a secondary command sequence; and
insert at least one command in the command sequence directing the graphics processing circuit to the secondary command sequence.

18. The storage medium as defined in claim 17, wherein the secondary command sequence includes at least one further command executable by the graphic processing circuit memory to update the memory address remapping table based on at least the real memory address of the at least one page entry.
